(19) United States
(12) Patent Application Publication
(10) Pub. No.: US 2004/0206247 A1
(43) Pub. Date: Oct. 21, 2004

(54) Decorative plate with three-dimensional figures

(75) Inventor: Tony Tseng, Taichung City (TW)

Correspondence Address: TROXELL LAW OFFICE PLLC, SUITE 1404, 5205 LEESBURG PIKE, FALLS CHURCH, VA, 22041, US

(73) Assignee: Taiwan Paiho Limited

(21) Appl. No.: 10/418,130

(22) Filed: Apr. 18, 2003

(51) Int. Cl. A47J 37/08

(52) U.S. Cl. 99/388

(57) ABSTRACT

A decorative plate with three-dimensional patterns is mainly made up of an upper layer and a lower layer of PPU materials wherein the upper layer is a transparent body and the lower layer has a top facet half-tone printed with figures of special design thereon. The upper layer has a plurality of pyramidal solid projections distributed at the top surface thereof, each forming more than two perspective sloping sides, a number of cutting lines defining the perspective sloping sides, and one cutting point disposed at the top thereof; whereby, figures disposed at the lower layer are refracted to give out vivid and floating appearance when the decorative plate is turned or adjusted in an angle. Moreover, the perspective sloping sides can refract different shapes of the figures while the cutting lines and the cutting point thereof can further divide and change the figures into different displays in a kaleidoscopic manner, effecting the variety and beauty of the decorative plate with three-dimensional figures.

### BACKGROUND OF THE INVENTION

The present invention is related to a decorative plate with three-dimensional figures mainly made up of an upper layer and a lower layer wherein said upper layer, a transparent body, has a plurality of pyramidal solid projections disposed at the top surface thereof, each having more than two perspective sloping sides, a number of cutting lines defining each said perspective sloping side thereof, and one cutting point disposed at the top thereof; whereby, figures of special design printed at the top facet of said lower layer can give out vivid and floating appearance when said decorative plate is turned in an angle. Moreover, via the refraction of said perspective sloping sides as well as the cutting lines and cutting point thereof, the figures thereof can be changed into different displays in a kaleidoscopic manner, effecting the variety and beauty of the decorative plate with three-dimensional figures.

Please refer to FIG. 1. A conventional decorative plate as shown in FIG. 1 is mainly made up of a transparent upper layer 11, and a non-transparent lower layer 12 wherein said lower layer 12 has a non-perspective top facet 121 corresponding to the bottom side of said upper layer 11 thereof and half-tone printed with decorative figures thereon. Said upper and lower layers 11, 12 are then pressure molded via an upper mold 20 and a lower mold 30, and securely fastened into an integral decorative plate 10 via high frequency vibration: Said decorative plate 10 is provided with a plurality of elongated arc solid projections 111 arranged consecutively at the upper surface thereon.

Please refer to FIG. 2. The decorative plate 10, adaptable to the surface of shoes, clothing, and leather articles, mainly comprises an upper layer 11 and a lower layer 12, which are made of plastic materials. Via the elongated arc solid projections 111 of the transparent upper layer 11, the decorative figures printed at the top facet 121 of the lower layer 12 thereon can be refracted to give out vivid and floating appearance when said decorative plate 10 is turned or adjusted in an angle.

However, there are some drawbacks to such conventional decorative plate 10. First, each of the elongated arc solid projections 111 thereof forms one single arc facet through which the figures printed at the lower layer 12 thereon are refracted in a single design no matter into what angles the decorative plate 10 is turned or adjusted, monotonously lacking variety in display. Second, the elongated arc solid projections 111 thereof must be turned into a straight angle so as to clearly reveal the design of the figures printed on the lower layer 12 thereof, inconveniently requiring the adjustment of a big angle to give out the floating appearance of the figures thereof. Third, the upper and lower layers 11, 12 are pressure molded and fastened via high frequency vibration, which can easily ruin the texture of the plastic materials and mar the clarity of the figures displayed at the lower layer 12 thereon.

### SUMMARY OF THE PRESENT INVENTION

It is, therefore, the primary purpose of the present invention to provide a decorative plate with three-dimensional figures mainly made up of an upper layer and a lower layer wherein said upper layer, a transparent body, has a plurality of pyramidal solid projections disposed at the top surface thereof, each having more than two perspective sloping sides, a number of cutting lines defining each of the perspective sloping sides, and a cutting point disposed at the top thereof, whereby, figures half-tone printed at the top facet of said lower layer can give out vivid and floating appearance when the decorative plate thereof is turned or adjusted in an angle. Moreover, the perspective sloping sides thereof can refract different displays of the figures while the cutting lines as well as the cutting point thereof can further divide and complicate the figures in a kaleidoscopic manner, effecting the variety and beauty of the decorative plate with three-dimensional figures.

It is, therefore, the secondary purpose of the present invention to provide a decorative plate with three-dimensional figures wherein, via the perspective sloping sides thereof, the pyramidal solid projections need only to be turned or adjusted in a slight angle, no more than a straight angle, to reveal clearly the figures printed on the lower layer thereof in vivid and floating appearance.

It is, therefore, the third purpose of the present invention to provide a decorative plate with three-dimensional figures wherein the upper and lower layers are pre-heated and softened before pressure molded via cold molds to avoid ruining the texture of the plastic materials thereof and, thus, to ensure the clarity of the figures revealed thereon.

### BRIEF DESCRIPTION OF THE DRAWINGS

FIG. 1 is a flow diagram showing the process of production of a conventional decorative plate.

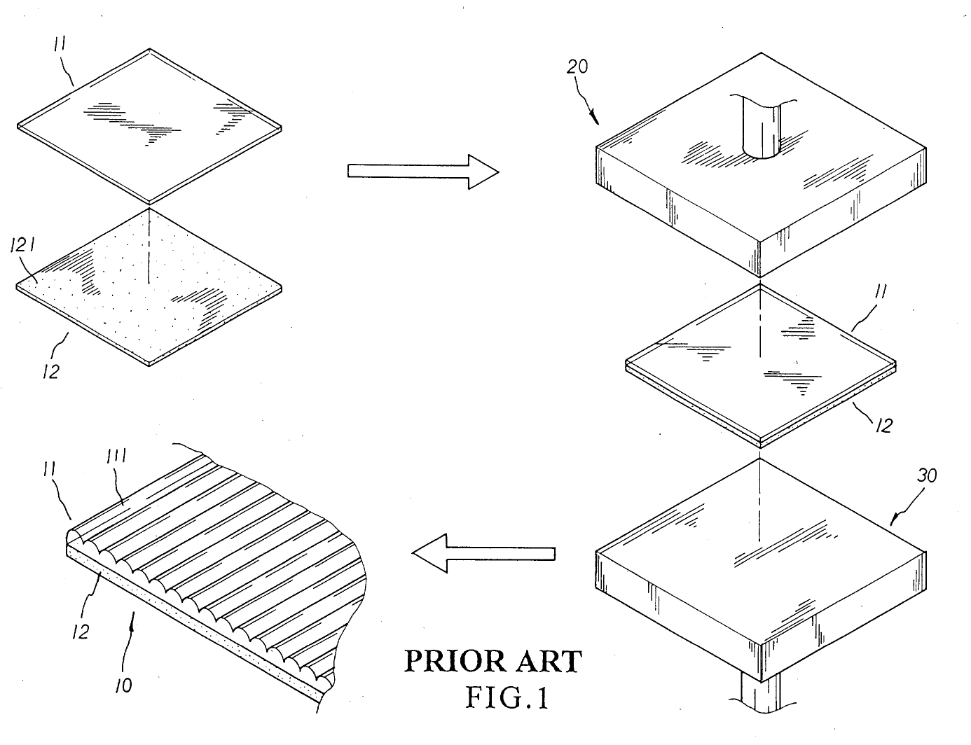

FIG. 2 is a perspective view of a conventional decorative plate.

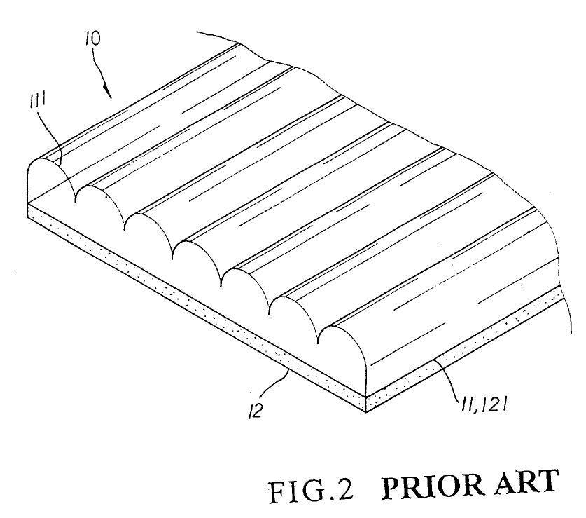

FIG. 3 is a flow diagram showing the process of production of the present invention.

FIG. 4 is a perspective view of the present invention.

### DETAILED DESCRIPTION OF THE PREFERRED EMBODIMENTS

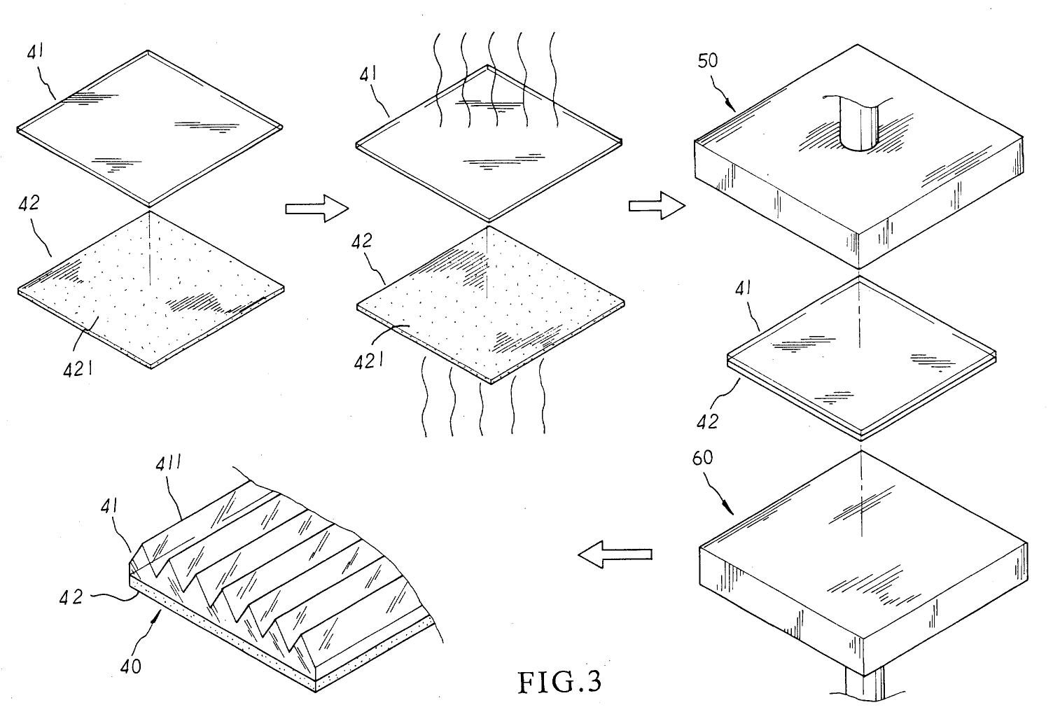

Please refer to FIG. 3. The present invention is related to a decorative plate with three-dimensional figures, comprising an upper layer 41 and a lower layer 42 made of PPU plastics. The lower layer 42 has a top facet 421 corresponding to the bottom side of the lower layer 41 and half-tone processed to form printed figures of special design thereon and a non-perspective surface thereof. The upper layer 41 and lower layer 42 printed with figures thereon are then heated and softened before located onto an upper cold mold 50 and a lower cold mold 60 respectively. The upper and lower layers 41, 42 are pressure molded via the upper and lower cold molds 50, 60 to form an integral decorative plate 40 with a plurality of pyramidal solid projections 411 distributed at the upper surface of the upper layer 41 thereof.

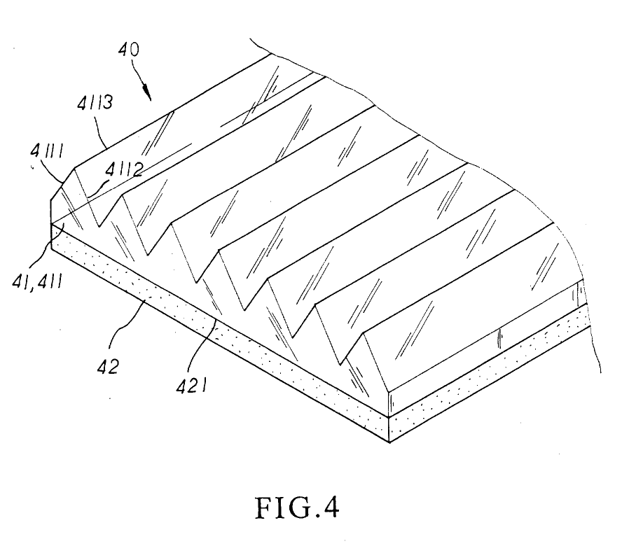

Please refer to FIG. 4. The decorative plate 40 adaptable to the surfaces of shoes, clothing, and leather articles, etc., are mainly made up the upper and lower layers 41, 42 of PPU plastics. The upper layer 41, a transparent body, has a plurality of the pyramidal solid projections 411 distributed at the upper surface thereof, each having more than two perspective sloping sides 4111, a number of cutting lines 4112 defining the perspective sloping sides 4111 thereof, and a cutting point 4113 disposed at the top thereof The lower layer 42, a non-transparent body, is half tone printed with figures of special design at the top facet 421 thereon. Via the refraction of the pyramidal solid projections 411 of the upper layer 41, the figures disposed at the top facet 421 thereof can give out vivid and floating appearance when the decorative plate 40 is turned or adjusted in an angle. Besides, the perspective sloping sides 4111 thereof can refract different shapes of the figures while the cutting lines 4112 and cutting point 4113 thereof can further divide and change the figures into different displays. Thus, via the perspective sloping sides 4111 as well as the cutting lines 4112 and the cutting point 4113 thereof, the figures printed on the lower layer 42 thereof can be verified into different displays in a kaleidoscopic manner, effecting the variety and beauty of the decorative plate 40. Moreover, the upper and lower layers 41, 42 are first heated and softened before pressure molded via the cold upper and lower molds 0, 60, to avoid ruining the texture of plastic materials thereof and ensure the clarity of the figures displayed at the lower layer 42 thereon.

What is claimed is:

1. A decorative plate with three-dimensional patterns, mainly made up of an upper layer, a lower layer wherein said upper layer is a transparent body and said lower layer, a non-transparent body, has a top facet corresponding to the bottom side of said lower layer and half-tone printed with figures of special design thereon; said decorative plate being characterized by that;
said upper layer having a plurality of pyramidal solid projections disposed at the top surface thereof, each having more than two perspective sloping sides, a number of cutting lines defining said perspective sloping sides thereof, and one cutting point disposed at the top thereof;
whereby, via the refraction of the pyramidal solid projections thereof, the figures disposed at the top facet of said lower layer can give out vivid and floating appearance when said decorative plate is turned or adjusted in an angle; moreover, the perspective sloping sides thereof can refract different shapes of the figures while the cutting lines and the cutting point thereof can further divide and change the figures into different displays in a kaleidoscopic manner, effecting the variety and beauty of said decorative plate thereof.

2. The decorative plate with three-dimensional patterns as claimed in claim 1 wherein the upper and lower layers of said decorative plate are made of PPU materials.
